(19) United States
(12) Patent Application Publication
(10) Pub. No.: US 2024/0017715 A1
(43) Pub. Date: Jan. 18, 2024

(54) HYBRID DRIVE SYSTEM WITH OPTIMIZED OPERATIONAL MODES

(71) Applicants: Clark E. ROBISON, Tomball, TX (US); Charles D. PARKER, Sugarland, TX (US)

(72) Inventors: Clark E. ROBISON, Tomball, TX (US); Charles D. PARKER, Sugarland, TX (US)

(21) Appl. No.: 18/475,718

(22) Filed: Sep. 27, 2023

Related U.S. Application Data
(63) Continuation of application No. 18/190,774, filed on Mar. 27, 2023.
(60) Provisional application No. 63/327,412, filed on Apr. 5, 2022.

(51) Int. Cl. B60W 20/15; B60W 10/26; B60W 10/06; F02D 41/02; B60W 10/08

(52) U.S. Cl. CPC B60W 20/15; B60W 10/26; B60W 10/06; F02D 41/021; B60W 10/08; B60W 2510/30; B60W 2710/0644; B60W 2510/244

(57) ABSTRACT

A motorized vehicle can include a ground-engaging wheel or propeller, an electric motor that rotates the wheel or propeller, an internal combustion engine, and a generator that produces electrical power in response to operation of the internal combustion engine. The motorized vehicle can include a controller that is configured to selectively supply the electrical power from the generator to a battery and/or the electric motor. A method of operating a motorized vehicle can include inputting journey data to a controller, the journey data including a journey distance and/or a journey destination, and the controller selecting a rotational speed of an internal combustion engine of the motorized vehicle based at least in part on the journey data.

### BACKGROUND

This disclosure relates generally to motorized vehicles and, in an example described below, more particularly provides a hybrid drive system with optimized operational modes.

In a typical motorized vehicle of the hybrid type, electrical power is supplied from batteries to electric motors used to drive wheels of the vehicle. Alternatively, or in addition, an internal combustion engine is used to drive the wheels.

When the internal combustion engine is used to drive the wheels, a rotational speed of the internal combustion engine is generally proportional to a rotational speed of the wheels and, thus, a forward speed of the motor vehicle. A transmission connected between the internal combustion engine and the wheels controls a ratio of the rotational speeds of the internal combustion engine and the wheels.

It will, therefore, be readily appreciated that improvements are continually needed in the art of constructing and operating hybrid motorized vehicles. Inventive principles described below provide such improvements to the art. The improvements may be used with a variety of different types of motorized vehicles, such as, cars, trucks, motorcycles, construction vehicles, airplanes, boats, etc.

### BRIEF DESCRIPTION OF THE DRAWINGS

FIG. 1 is a representative schematic view of an example of a motorized vehicle which can embody principles of this disclosure.

FIG. 2 is a representative graph of an example of torque and horsepower versus engine speed for an internal combustion engine of the motorized vehicle.

FIG. 3 is a representative flowchart for an example of logic of a controller of the motorized vehicle.

FIG. 4 is a representative schematic view of another example of a motorized vehicle that embodies principles of this disclosure.

### DETAILED DESCRIPTION

One example of a motorized vehicle described herein includes one or more electric motors to drive wheels of the motorized vehicle. A controller supplies electrical power from one or more batteries to the electric motors as needed to propel the vehicle forward or backward.

In addition, the vehicle includes an internal combustion engine. The internal combustion engine does not drive the wheels of the vehicle directly (or via a transmission, drive shafts, etc.). Instead, the internal combustion engine drives a generator, which charges the batteries via the controller. In some situations, electrical power produced by the generator can be supplied to the electric motors via the controller. Note that, as used herein, the term “generator” includes any type of device that produces electrical power from mechanical input (i.e., converts mechanical energy to electrical energy), and includes devices such as alternators.

To ensure that the internal combustion engine is operated in a highly efficient manner, a rotational speed (e.g., revolutions per minute or rpm) of the engine is generally maintained at a minimal level that will still provide sufficient torque to drive the generator. In this manner, an electrical power demand of the vehicle can be satisfied by the output of the generator, and the batteries can be maintained in a charged condition, with efficient operation of the internal combustion engine.

In an example described below, five operating modes are defined and optimized based on the type of internal combustion engine selected and its unique operating conditions. In a first operating mode, the internal combustion engine is stopped (zero rpm) when the batteries that are used to provide power to the electric motors have a charge status that is sufficient to provide all the required electrical power for the electric motors driving the wheels.

In a second operating mode, the rotational speed of the internal combustion engine is set at an idle level (minimal rpm). This operating mode would be useful in cold climates when a heat source is required or in warm climates when air conditioning is required. As will be readily appreciated, operation of the internal combustion engine at idle will be very fuel efficient.

In a third operating mode, the rotational speed of the internal combustion engine is selected based on an optimum torque output for the internal combustion engine. This allows the generator to supply sufficient electrical power to recharge the batteries. The optimum torque output will preferably occur at a relatively low rpm level, and so this third operating mode is also a relatively efficient one for the internal combustion engine.

In a fourth operating mode, the rotational speed of the internal combustion engine is determined by the electrical power required to drive the motors directly, with reduced or no contribution from the batteries (such as, due to a low battery charge condition). The rotational speed of the internal combustion engine in this fourth operating mode is typically at a higher level than the third, optimum torque, operating mode, but is selected to be the minimal rotational speed that will provide the required power.

A fifth operating mode results from an operator selecting an enhanced or “high performance” output level. In this mode, the rotational speed of the internal combustion engine is determined by the maximum power output of the internal combustion engine. In some examples, the rotational speed of the internal combustion engine can be controlled by the controller in such a way to optimize the power output (e.g., in this mode the rpm might vary to meet the electrical power demand of the vehicle). In some examples, the rotational speed is based on a position of an accelerator pedal of the vehicle.

Although five operating modes are described herein, more or fewer operating modes may be used in other examples. For example, if the vehicle is not equipped with the capability of conveniently stopping and starting the internal combustion engine, the first operating mode described above may not be used.

Because the operating parameters for existing internal combustion engines vary based on engine type and fuel type, operation of the internal combustion engine could be further optimized. For example, diesel engines typically achieve maximum torque at much lower rpms than gasoline engines. Therefore, the anticipated efficiency of the diesel internal combustion engine makes it a preferred choice.

Additionally, if the fuels used to drive these engines are configured to have a more consistent burn rate, additional improvements and efficiencies can be achieved. The use of clean burning fuels (such as, liquefied natural gas, hydrogen, propane, etc.) would also provide more benefit in the form of less hydrocarbon output from an efficient use of the engine.

Furthermore, engine cycles can be selected to provide even more benefits. For example, a Stirling engine cycle might result in even more efficiencies. In addition, other engine cycles have recently been introduced, such as the Atkinson cycle by Toyota, and the High Efficiency Hybrid cycle by LiquidPiston. Any of these engine cycles can be used to drive the generator in an efficient manner.

The onboard computer/controller managing the engine operation could assess the electrical power demands based on battery condition and an anticipated driving mode. The controller can select a configuration or plan for a journey and a corresponding appropriate engine operating mode, based on factors such as, range (journey distance), whether the journey will take place in a city (that includes numerous start and stop cycles) or on high-speed highways (where the driving conditions are more consistent), or maximum power output needs, and make additional changes to the engine operation to further enhance operational efficiencies.

For a typical journey, the operator can input to the controller electronics the nature of the driving conditions anticipated (i.e., predominately city, highway, mixed mode, etc.), and an estimate of the distance. A destination may be input to a GPS (global positioning system) unit of the controller, instead of the distance, so that the controller can determine the distance to be traveled.

The controller electronics determine whether the existing battery charge is sufficient for the anticipated electrical power requirements of the journey. In some examples, the controller electronics can assess ambient weather conditions and determine whether the vehicle will require heating or cooling. If conditions dictate that heating or cooling is required, the internal combustion engine is operated to provide electrical power for the heating or cooling, to drive an air conditioning compressor, or to pump water heated by the internal combustion engine.

During the trip, if the battery charge is determined to be too low, the internal combustion engine rpm can be increased (e.g., in the fourth operating mode described above) to operate the generator in battery charge mode. This operation may be affected if the operator indicates a charging station will be available at any intermediate stops, or the onboard computer can access certain websites or databases giving even more precise guidance on whether or not there are any charging stations on the selected route, or the controller may use an intelligent navigation system to recommend a route with charging stations. The controller may also determine the most economical route using the intelligent navigation system, based on operator priorities (such as, quickest route, least emissions from the internal combustion engine, etc.).

During the journey, if the battery charge level is not sufficient for the driving conditions, the internal combustion engine rpm may be increased automatically to a higher output rpm, so that the generator provides up to 100% of the electrical power required to operate the vehicle.

In each of the operational modes, the controller electronics not only assess the power required from the internal combustion engine, it also determines the most economical operation of the engine for a given fuel source. For example, in the event propane is selected in lieu of diesel or gasoline, the internal combustion engine rpm may be increased slightly to accommodate the lower heating value of the propane as compared to gasoline or diesel. The engine operation could also be further optimized by varying the timing of the spark for a gasoline engine, or the injection timing for a diesel engine.

Recent advances in gasoline engines that autonomously determine the number of cylinders that are used to meet the torque requirements could also be applied in order to further affect the efficiency of the engine operation. Any other efficiency enhancements that are available for the engine type could be applied to further enhance the fuel consumption efficiency or power output, or decrease emissions.

Allowing the batteries to be recharged with an outboard charging system (such as, when at a residence so equipped, or at a charging station) would further improve the overall efficiency of the hybrid operation. For example, if a charging station is available along the journey route, the controller can select to use the batteries exclusively or predominately (and not to use the internal combustion engine, or to use the internal combustion engine only a minimal amount of time), if there is sufficient time allotted for the journey to include stopping at the charging station to recharge the batteries.

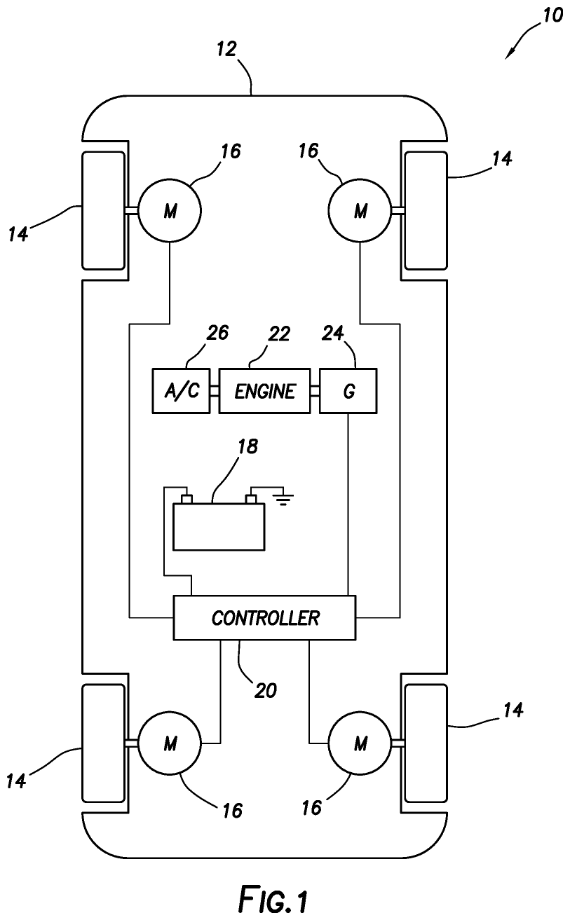

Representatively illustrated in FIG. 1 is a motorized vehicle 10 and associated method which can embody principles of this disclosure. However, it should be clearly understood that the vehicle 10 and method are merely one example of an application of the principles of this disclosure in practice, and a wide variety of other examples are possible. Therefore, the scope of this disclosure is not limited at all to the details of the vehicle 10 and method described herein and/or depicted in the drawings.

In the FIG. 1 example, the motorized vehicle 10 includes a body or chassis 12 and four rotatable ground-engaging wheels 14 for propelling the chassis. In actual practice, the wheels 14 are typically provided with tires. Other numbers of wheels may be used in other examples.

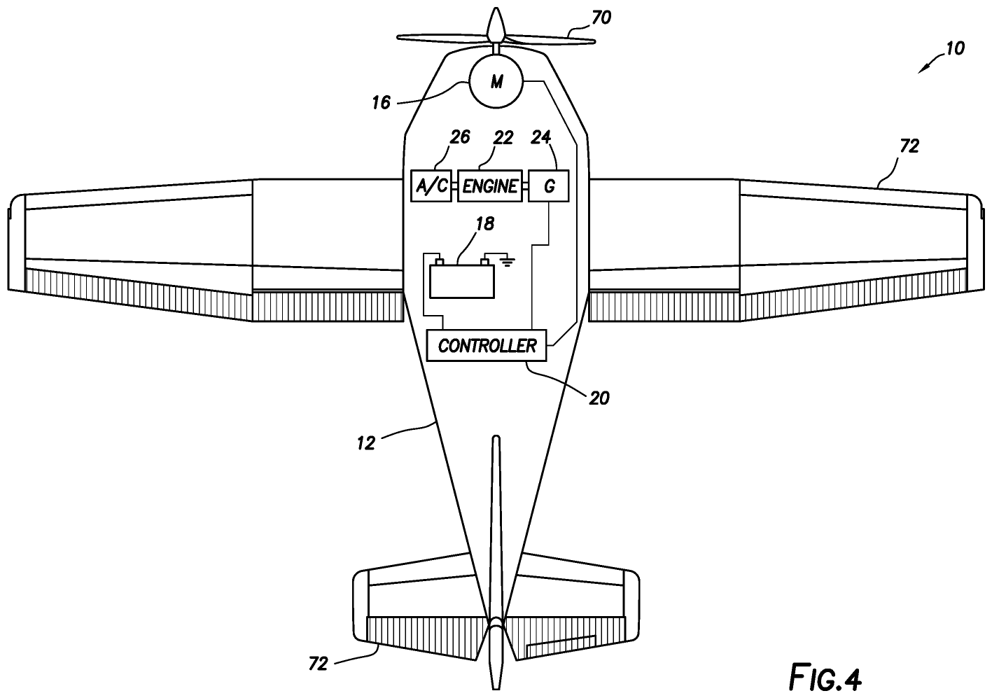

Furthermore, it is not necessary for a vehicle incorporating the principles of this disclosure to include wheels for propelling the vehicle (for example, see the FIG. 4 example, in which a propeller is used to propel a vehicle). Thus, the scope of this disclosure is not limited to any particular details of the FIG. 1 vehicle 10 or any of its components.

An electric motor 16 is used to rotate each of the wheels 14 in the FIG. 1 example. As depicted in FIG. 1, a separate electric motor 16 is provided for rotation of each of the wheels 14. However, in other examples, a single electric motor can be used to rotate multiple wheels, and it is not necessary for every wheel to be rotated by an electric motor. Thus, the scope of this disclosure is not limited to any particular number of wheels, any particular number of electric motors, or any particular relationship between the number of wheels and the number of electric motors.

At least one battery 18 is used to store electrical energy in the vehicle 10. A control system or controller 20 supplies electrical power from the battery 18 to the electric motors 16 as appropriate, and in response the electric motors drive the wheels 14.

The controller 20 can include electronic circuitry, processors, memory, databases, programmed instructions, input and output devices, a programmable logic controller, etc., to enable the controller to perform its function of controlling operation of the electric motors 16. For example, the controller 20 can be configured to select one of the above-described operating modes in response to operator inputs (such as, journey data including journey distance or destination, whether high performance mode is desired, accelerator pedal position, etc.), environmental conditions, a state of charge of the battery 18, and other parameters.

An internal combustion engine 22 is used to drive a generator 24 of the vehicle 10. The internal combustion engine 22 may use any type of fuel (gasoline, diesel, liquefied natural gas, propane, hydrogen, etc.). The generator 24 may produce direct or alternating current.

The electrical power output of the generator 24 is supplied to the controller 20. The controller 20 may direct the electrical power output of the generator 24 to charge the battery 18 and/or to drive the electrical motors 16 directly (such as, in the fourth or fifth operating modes described above).

In the FIG. 1 example, a heating and/or air conditioning unit 26 is driven by the internal combustion engine 22. In some examples, the unit 26 may include an air conditioning compressor, and in other examples the unit 26 may only provide for heating a passenger compartment of the vehicle 10.

Note that the internal combustion engine 22 is not mechanically connected to any of the wheels 14 (such as, via a transmission, drive shaft, differential, etc.). Instead, the motors 16 drive the wheels 14 in response to electrical power supplied via the controller 20 from the battery 18 and/or the generator 24. Thus, a forward speed of the vehicle 10 is not proportional to a rotational speed of the internal combustion engine 22.

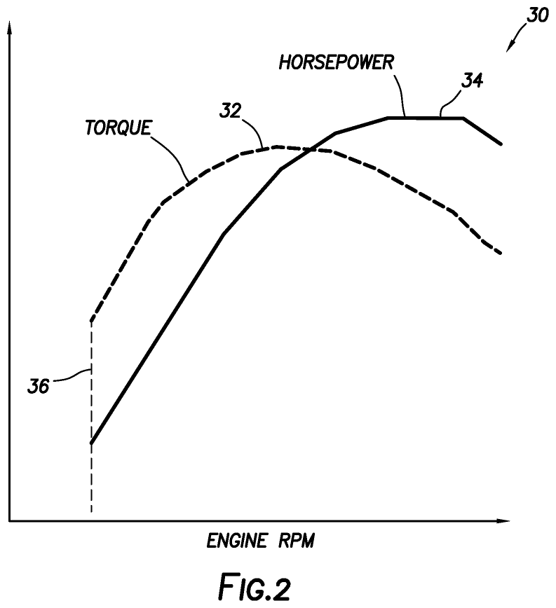

Referring additionally now to FIG. 2, an example graph 30 of horsepower and torque versus engine rotational speed (rpm) for the internal combustion engine 22 is representatively illustrated. In this example, the internal combustion engine 22 is a diesel engine, but other types of engines may be used in other examples.

As will be appreciated by those skilled in the art, a diesel engine typically develops maximum torque 32 at an engine rpm that is much less than an engine rpm at which the diesel engine develops maximum horsepower 34. Thus, a diesel engine can be used to efficiently drive the generator 24 to produce electrical power when needed (such as, in the second and third operating modes described above) at relatively low engine rpm.

At idle 36, only minimal torque and horsepower are produced by the diesel engine, but the diesel engine is operated at maximum efficiency. The diesel engine can be operated at idle 36, for example, in the second operating mode described above (such as, when the battery 18 is fully charged, but the heating or air conditioning unit 26 is being operated).

The controller 20 selects the engine rpm based on the operator inputs (such as, journey data including journey distance or destination, whether high performance mode is desired, accelerator pedal position, etc.), environmental conditions, the type of internal combustion engine 22, the state of charge of the battery 18, and other parameters, as described above. For example, in the first operating mode, the controller 20 can cause the internal combustion engine 22 to be stopped (zero rpm). In the second operating mode, the controller 20 can cause the internal combustion engine 22 to operate at idle 36. In the third operating mode, the controller 20 can cause the internal combustion engine 22 to operate at optimum or maximum torque 32. In the fourth operating mode, the controller 20 can cause the internal combustion engine 22 to operate at an engine rpm that is greater than the maximum torque 32 engine rpm. In the fifth operating mode, the controller 20 can cause the internal combustion engine 22 to operate at the maximum horsepower 34 engine rpm. Of course, other operating modes and other engine rpm levels or ranges may be used in other examples.

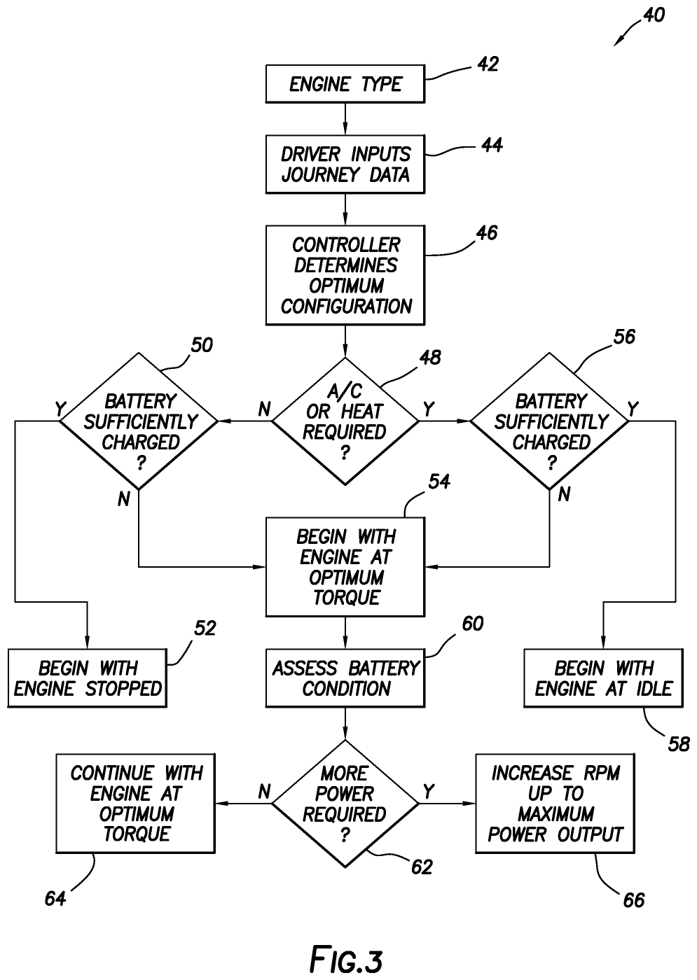

Referring additionally now to FIG. 3, a method 40 of operating the motorized vehicle 10 is representatively illustrated. The method 40 may be incorporated into programmed logic of the controller 20.

In step 42, the type of internal combustion engine 22 is a parameter used by the controller 20 to control operation of the engine. The engine type can include the fuel (e.g., diesel, gasoline, propane, liquefied natural gas, propane, hydrogen, etc.) and cycle type (e.g., two- or four-cycle, Stirling cycle, Atkinson cycle, High Efficiency Hybrid cycle, etc.).

In step 44, the operator/driver inputs data regarding a journey to be taken. The data may include the journey distance or the journey destination as described above. The operator may also input whether highways (such as, interstate highways) are to be taken, an amount of time allotted for the journey, whether the battery 18 is to be charged at a charging station during the journey, whether the high performance operating mode is desired, and any other relevant data that may be used by the controller 20 to plan an appropriate configuration for the journey.

In step 46, the controller determines an optimum configuration for the journey. The configuration includes a selected initial operating mode for the internal combustion engine 22, whether the battery 18 will be charged using the electrical power output of the generator 24 and/or via a charging station, whether the battery charge will be significantly depleted at an end of the journey, etc.

In step 48, a determination is made as to whether air conditioning or heating is required. This determination may be made in response to operator input (i.e., the operator selects heating or air conditioning), or in response to input from a temperature sensor.

In step 50, an evaluation is made as to whether the battery 18 is sufficiently charged for the journey. If the battery 18 is sufficiently charged, and no heating or air conditioning is required (step 48), then the journey can begin with the internal combustion engine 22 stopped (step 52). The journey can proceed with the controller 20 supplying electrical power to the motors 16 exclusively from the battery 18.

In step 56, the same determination is made as in step 50, in the situation in which heating or air conditioning is required (step 48). If the battery 18 is not sufficiently charged in step 50 or step 56, then the journey begins with the internal combustion engine 22 at the optimum torque 32 engine rpm (step 54). If heating or air conditioning is required (step 48), but the battery 18 is sufficiently charged for the journey (step 56), then the journey begins with the internal combustion engine 22 at engine idle 36 rpm (step 58).

In step 60, during the journey the battery 18 condition or state of charge is periodically or continuously evaluated to determine whether the battery is sufficiently charged to complete the journey according to the selected configuration (step 46).

In step 62, a determination is made as to whether additional power output is required of the internal combustion engine 22. For example, if the battery 18 is being discharged more rapidly than anticipated, so that additional electrical power output from the generator 24 is required to charge the battery 18, then the rotational speed of the internal combustion engine 22 may be increased (step 66) up to the maximum horsepower 34 engine rpm. If additional power output is not required of the internal combustion engine 22, then the internal combustion engine may continue to be operated at the optimum torque 32 engine rpm (step 64).

Referring additionally now to FIG. 4, another example of the motorized vehicle 10 is representatively illustrated. In this example, the vehicle 10 does not include the wheels 14 for propelling the vehicle. Instead, an electric motor 16 is used to rotate a propeller 70, in order to propel the vehicle 10. However, the FIG. 4 vehicle 10 could include wheels, for example, to allow for transporting the vehicle while it is not airborne.

In the FIG. 4 example, the vehicle body or chassis 12 is in the configuration of an airplane, with wings 72 provided for lifting the vehicle 10 when it is propelled in a forward direction due to rotation of the propeller 70. In other examples, the chassis 12 may not include wings (such as, if the vehicle 10 is in the form of a helicopter, or a lighter-than-air or buoyant vehicle). Thus, the scope of this disclosure is not limited to any particular details of the flight-capable FIG. 4 vehicle 10 described herein or depicted in the drawings.

Electrical power may be supplied to the electric motor 16 by the controller 20 in the FIG. 4 example in a manner that is the same as, or similar to, the manner described above for the FIGS. 1-3 example. The same operating modes may be used as described above, or other operating modes may be used as desired.

For example, the first operating mode described above may not be used while the vehicle 10 is in flight if it is considered undesirable or unsafe to start the internal combustion engine 22 while the vehicle is airborne. However, the first operating mode can be used with the FIG. 4 vehicle 10 example, if desired.

In yet another example, the vehicle chassis 12 may be in the configuration of a boat, ship, submarine or any type of water-borne vessel. Thus, the scope of this disclosure is not limited to any particular type of vehicle designed for transport over or through land, air or water, or any combination thereof.

It may now be fully appreciated that the above disclosure provides significant advancements to the art of constructing and operating hybrid motorized vehicles. In examples described above, the internal combustion engine 22 is operated at a minimum rotational speed that causes sufficient electrical power to be produced by the generator 24 for a planned journey. The controller 20 can select an operating mode for the internal combustion engine 22 that is appropriate for a planned journey configuration.

The above disclosure provides to the art a motorized vehicle 10 that in one example comprises a wheel 14 or propeller 70 configured to rotate and thereby propel the motorized vehicle 10, an electric motor 16 configured to rotate the wheel 14 or propeller 70, an internal combustion engine 22, and a generator 24 configured to produce electrical power in response to operation of the internal combustion engine 22.

The motorized vehicle 10 can include a battery 18 and a controller 20. The controller 20 may be configured to selectively supply the electrical power to the battery 18.

The controller 20 may be further configured to supply the electrical power to the electric motor 16, to regulate a rotational speed of the internal combustion engine 22, and/or to select a rotational speed of the internal combustion engine 22 based on journey data input by an operator. The controller 20 may be configured to regulate a rotational speed of the internal combustion engine 22 so that the rotational speed is at an idle 36 speed when a battery 18 of the motorized vehicle 10 is fully charged and a heating or air conditioning unit 26 of the motorized vehicle 10 is deactivated, and the rotational speed is greater than the idle 36 speed when the battery 18 is not fully charged.

A forward speed of the motorized vehicle 10 may not be proportional to a rotational speed of the internal combustion engine 22.

The above disclosure also provides to the art a method 40 of operating a motorized vehicle 10. In one example, the method 40 can include inputting journey data to a controller 20 of the motorized vehicle 10, with the journey data including at least one of a journey distance and a journey destination, and the controller 20 selecting a rotational speed of an internal combustion engine 22 of the motorized vehicle 10 based at least in part on the input journey data.

The controller 20 may further select the rotational speed based on whether a heating or air conditioning unit 26 of the motorized vehicle 10 is activated. The controller 20 may further select the rotational speed based on whether a battery 18 of the motorized vehicle 10 is fully charged.

The controller 20 may select the rotational speed of zero, when a battery 18 of the motorized vehicle 10 is fully charged and a heating or air conditioning unit 26 of the motorized vehicle 10 is deactivated.

The controller 20 may select the rotational speed of idle, when a battery 18 of the motorized vehicle 10 is fully charged and a heating or air conditioning unit 26 of the motorized vehicle 10 is activated.

The controller 20 may select the rotational speed that produces maximum torque 32, when a battery 18 of the motorized vehicle 10 is not fully charged.

The controller 20 may supply electrical power from a battery 18 to an electric motor 16 that drives a ground-engaging wheel 14 or a propeller 70 of the motorized vehicle 10.

The electrical power may be supplied to the controller 20 from a generator 24 driven by the internal combustion engine 22.

A motorized vehicle 10 described above can comprise: an internal combustion engine 22, a generator 24 configured to be driven by the internal combustion engine 22, a battery 18, an electric motor 16 configured to rotate a wheel 14 of the motorized vehicle 10, and a controller 20 that is configured to selectively supply electrical power from the generator 24 to at least one of the battery 18 and the electric motor 16.

It should be understood that the embodiments described herein are merely examples of useful applications of the principles of the disclosure, which is not limited to any specific details of these embodiments. Although the embodiments described above include certain combinations of features, it should be understood that it is not necessary for all features of an embodiment to be used. Instead, any of the features described above can be used, without any other particular feature or features also being used.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

1-20. (canceled)

21. A hybrid drive motor vehicle, comprising:
at least one ground-engaging wheel configured to propel the vehicle;
an internal combustion engine, wherein the internal combustion engine is configured to mechanically drive a generator, and wherein the internal combustion engine is not configured to mechanically rotate the at least one wheel;
wherein the generator is configured to provide electrical power to a controller;
wherein the controller is configured to provide the electrical power to at least one battery;
wherein the controller is further configured to provide the electrical power to at least one electric motor directly from the generator; and
wherein the at least one electric motor is configured to rotate the at least one wheel.

22. The hybrid drive motor vehicle of claim 21, wherein the controller is further configured to selectively supply the electrical power from the at least one battery to the at least one electric motor.

23. The hybrid drive motor vehicle of claim 21, wherein the controller is further configured to regulate a rotational speed of the internal combustion engine.

24. The hybrid drive motor vehicle of claim 23, wherein the controller is configured to regulate the rotational speed of the internal combustion engine so that the rotational speed is at an idle speed when the at least one battery is fully charged and the rotational speed of the internal combustion engine is greater than the idle speed when the at least one battery is not fully charged.

25. The hybrid drive motor vehicle of claim 21, wherein the at least one electric motor receives the electrical power without the electrical power having been previously stored in the at least one battery.

26. A method of operating the hybrid drive motor vehicle of claim 21, the method comprising the steps of:
inputting journey data to the controller, the journey data including at least one of a journey distance and a journey destination;
the controller selecting a rotational speed of the internal combustion engine based at least in part on the journey data;
the internal combustion engine mechanically driving the generator;
the generator providing the electrical power to the controller;
the controller providing the electrical power to the at least one electric motor directly from the generator; and
the at least one electric motor rotating the at least one wheel.

27. The method of claim 26, further comprising the controller selectively supplying electrical power from the at least one battery to the at least one electric motor.

28. The method of claim 26, further comprising the controller regulating a rotational speed of the internal combustion engine.

29. The method of claim 28, further comprising the controller regulating the rotational speed of the internal combustion engine, wherein the rotational speed is at an idle speed when the at least one battery is fully charged and the rotational speed of the internal combustion engine is greater than the idle speed when the at least one battery is not fully charged.

30. The method of claim 28, further comprising the controller increasing the rotational speed of the internal combustion engine so that the controller can provide electrical power to the at least one battery and charge the at least one battery when a charge status of the at least one battery is insufficient to achieve the journey destination.

31. The method of claim 28, further comprising the controller regulating the rotational speed of the internal combustion engine to enable the controller to provide power to an air conditioning unit based on environmental conditions.

32. The method of claim 28, further comprising the controller regulating the rotational speed of the internal combustion engine based on a charge status of the at least one battery.

33. The method of claim 26, further comprising the controller selectively supplying power from the generator to the at least one battery and to the at least one electric motor.

34. The method of claim 26, further comprising the at least one electric motor receiving the electrical power without the electrical power having been previously stored in the at least one battery.

35. A hybrid drive motor vehicle, comprising:
at least one propeller configured to propel the vehicle;
an internal combustion engine, wherein the internal combustion engine is configured to mechanically drive a generator, and wherein the internal combustion engine is not configured to mechanically rotate the at least one propeller;
wherein the generator is configured to provide electrical power to a controller;
wherein the controller is configured to provide the electrical power to at least one battery;
wherein the controller is further configured to provide the electrical power to at least one electric motor directly from the generator; and
wherein the at least one electric motor is configured to rotate the at least one propeller.
